(19) United States
(12) Patent Application Publication
(10) Pub. No.: US 2012/0252276 A1
(43) Pub. Date: Oct. 4, 2012

(54) ELECTRICAL CARD CONNECTOR WITH CONTACTS HAVING SHARED SOLDERING TAIL

(75) Inventors: FANG-YUE ZHU, Kunshan (CN); JIAN-FEI YU, Kunshan (CN); QI-JUN ZHAO, Kunshan (CN)

(73) Assignee: HON HAI PRECISION INDUSTRY CO., LTD., New Taipei (TW)

(21) Appl. No.: 13/437,008

(22) Filed: Apr. 2, 2012

(30) Foreign Application Priority Data
Apr. 1, 2011 (CN) 201120094129.5

(51) Int. Cl. H01R 24/60

(52) U.S. Cl. 439/630

(57) ABSTRACT

An electrical card connector comprises an insulative housing having an inserting slot for receiving a first card and a second card, and a plurality of contacts retained in the housing respectively and including a plurality of first contacts for engaging with the first card, and a plurality of second contacts cooperating with the first contacts for engaging with the second card. The first contacts and the second contacts have retaining portions fixed with the housing, contact portions protruding into the inserting slot from the retaining portions, and soldering portions extending beyond the housing from the retaining portions. The contact portions of the first contacts and the contact portions of the second contacts are positioned at different position along a front-to-back direction. At least one of the first contacts and one of the second contacts share a same soldering tail.

### BACKGROUND OF THE INVENTION

1. Field of the Invention

The present invention generally relates to an electrical card connector and more particularly to an electrical card connector with contacts having shared soldering tail.

2. Description of Related Art

A conventional electrical card connector is usually used in electrical equipments such as desktop, notebook, mobile phones and the like for contacting with various types of electrical cards to transmit information therebetween. The electrical card connector is mounted on a printed circuit board, and comprises an insulative housing defining an inserting slot for receiving a first card and a second card, and a plurality of contacts retained in the housing. The contacts may include a plurality of first contacts and a plurality of second contacts both of which are arranged along a front-to-back direction. Each of the contacts includes a contact portion protruding into the inserting slot, a retaining portion secured in the housing, and a soldering tail extending beyond the housing for being soldered on a printed circuit board.

Both of the first and the second contacts contact with the first electrical card while the first electrical card is inserted into the inserting slot, and only the second contacts contact with the second electrical card while the second card is inserted into the inserting slot. However, the soldering tails of the first contacts forwardly extend beyond the housing and are aligned in one row along a left-to-right direction. The soldering tails of the second contacts backwardly extend beyond the housing and are aligned in another row along the left-to-right direction. The soldering tails of the first and the second contacts need to be soldered onto the printed circuit board, making the soldering process more complicated.

It is thus desired to provide an electrical card connector having improved contacts.

### SUMMARY OF THE INVENTION

According to one aspect of the present invention, an electrical card connector is adapted for being mounted on a printed circuit board and comprises an insulative housing having an inserting slot for receiving a card and a plurality of contacts retained in the housing respectively. The contacts include a plurality of first contacts, and a plurality of second contacts cooperating with the first contacts for engaging with the card. Each of the first contacts and the second contacts has a retaining portion fixed with the housing, a contact portion protruding into the inserting slot from the retaining portion, and a soldering portion extending beyond the housing from the retaining portion. The contact portions of the first contacts are arranged in one row extending along a left-to-right direction. The contact portions of the second contacts are arranged in another row parallel to the row. Wherein at least one of the first contacts and one of the second contacts share a same soldering tail.

According to another aspect of the present invention, an electrical card connector comprises an insulative housing having an inserting slot, and a plurality of contacts each having a retaining portion fixed with the housing, a contact portion protruding into the inserting slot, and a soldering tail extending beyond the housing from the retaining portion. The contact portions of the contacts are arranged in a first row and a second row disposed at front of the first row. Both of rows of the contact portions are adapted for engaging with one card. Wherein the contact has a grounding contact, which has two contact portions located in the first and second rows respectively.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is an assembled perspective view of an electrical card connector with a first card and a second card according to the present invention;

FIG. 2 is a partially exploded perspective view of the electrical card connector while a metal shell being aparted from an insulative housing thereof;

FIG. 3 is an exploded perspective view of the electrical card connector;

FIG. 4 is a view similar to FIG. 3, while taken from a different aspect; and

FIG. 5 is a perspective view of a plurality of contacts of the electrical card connector shown in FIG. 1;

### DETAILED DESCRIPTION OF THE INVENTION

Reference will now be made to the drawing figures to describe the preferred embodiment of the present invention in detail.

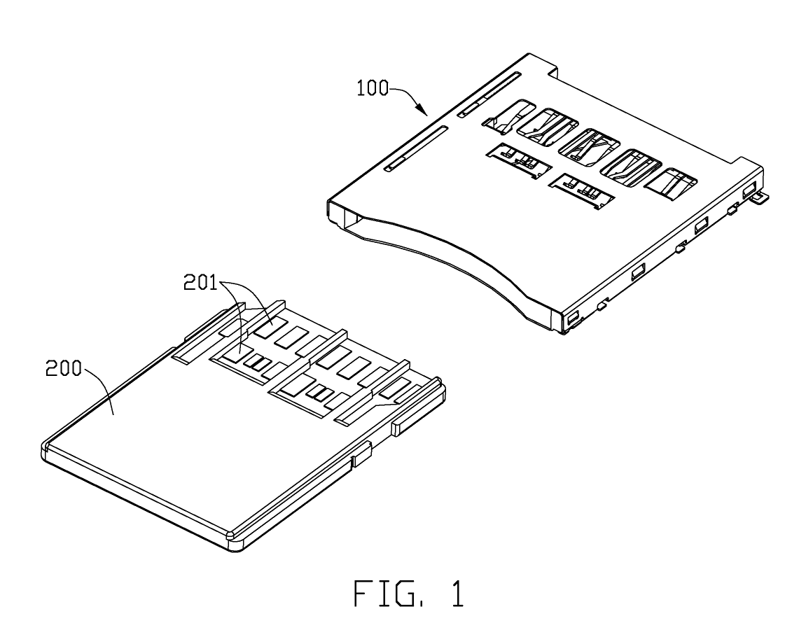

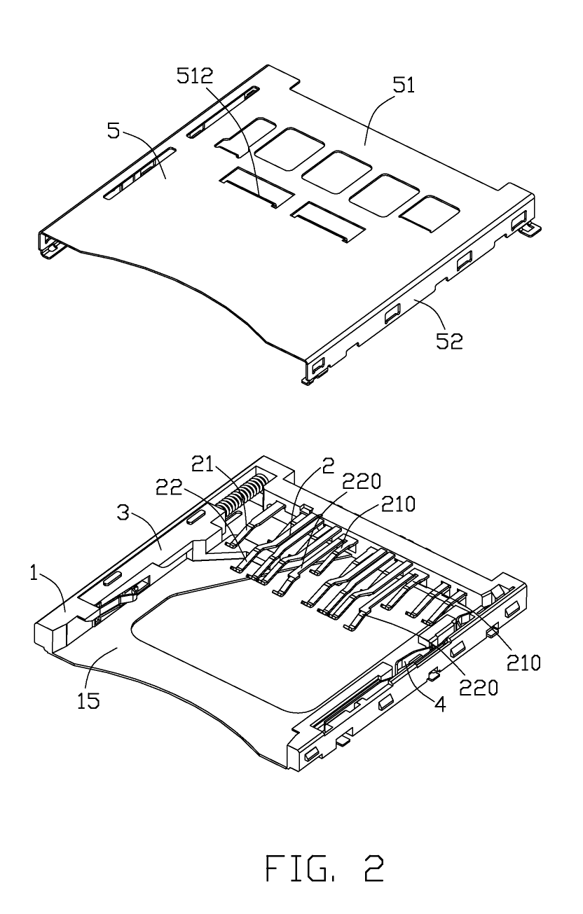

Referring to FIGS. 1-2, an electrical card connector 100 according to the present invention is used for connecting a first card (not shown) and a second card 200 to a printed circuit board (not shown). The first card is a super density secure digital card (SD), and the second card 200 is a new card having two rows of metal pads 201 in a front-to-back direction. The electrical card connector comprises an insulative housing 1, a plurality of contacts 2 mounted in the housing 1, an ejector mechanism 3, a switch 4, and a metal shell 5 covering the housing 1.

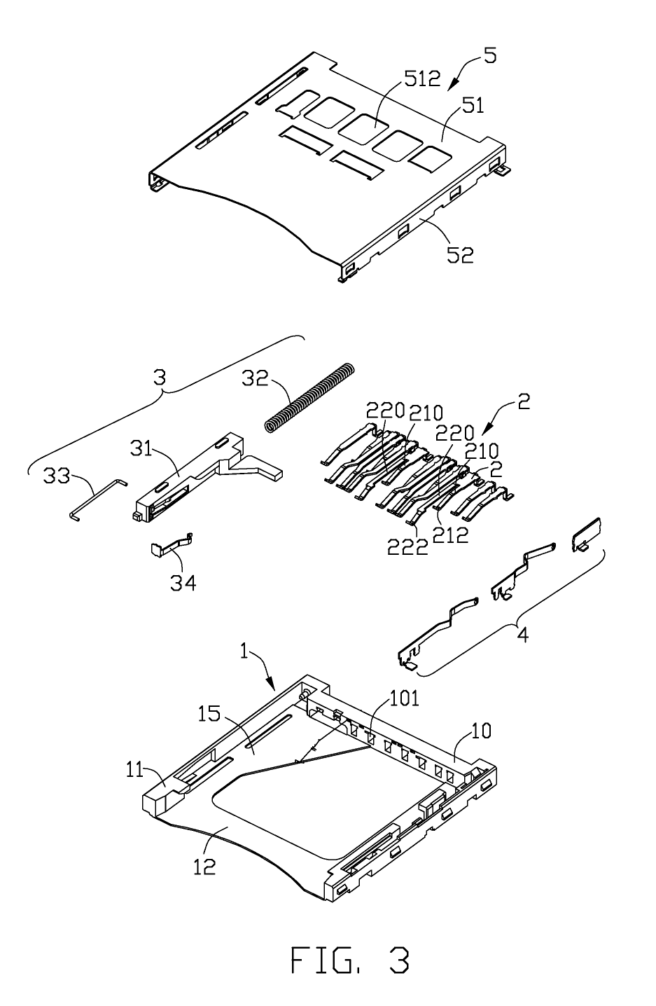

Referring to FIG. 3, the housing 1 includes a base portion 10, a pair of side walls 11 forwardly extending from two opposited ends of the base portion 10, a bottom wall 12 connecting with the pair of side walls 11, and an inserting slot 15 formed thereamong for receiving the first cad and the second card 200. The base portion 10 defines a plurality of passageways 101 for retaining the contacts 2.

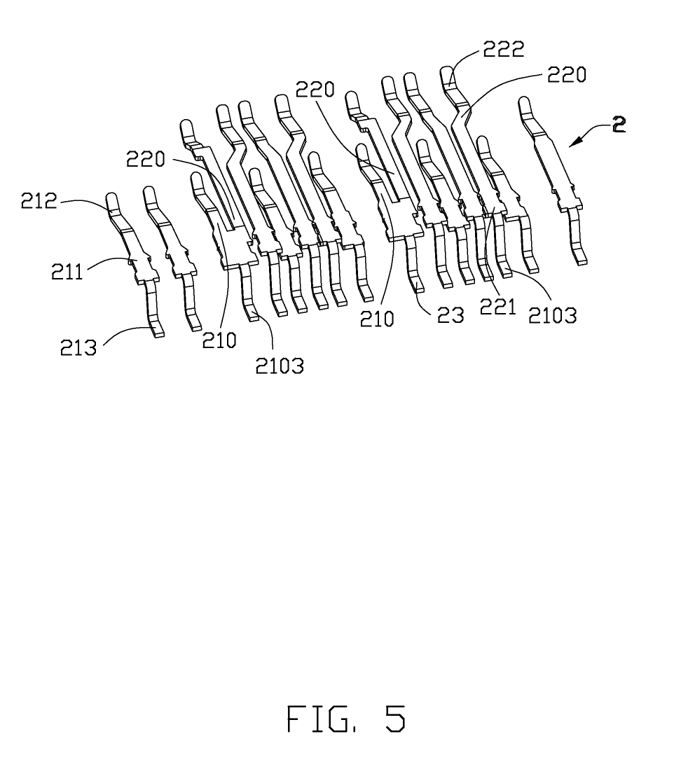

Referring to FIGS. 3 and 5, the contacts 2 are divided into a plurality of first contacts 21 for engaging with the first card, and a plurality of second contacts 22. Both of the first and the second contacts 21, 22 are adapted for engaging with the second card 200. The first and the second contacts 2 include a plurality of retaining portions 211, 221 received in the passageways 101 of the housing 1, a plurality of contact portions 212, 222 protruding into the inserting slot 15 from corresponding retaining portions 211, 221, and a plurality of soldering tails 213, 223 backwardly extending from the retaining portions 211, 221 and beyond the housing 1 to be soldered onto a printed circuit board. The contact portions 212 of the first contacts 21 are aligned in one row along a left-to-right direction. The contact portions 222 of the second contacts 22 are aligned in another row along the left-to-right direction which is located at front of the row of the contact portions 212 of the first contacts 21. The contact portions 212, 222 of the first and the second contacts 21, 22 are disposed at a same level in an upper-to-lower direction. The soldering tails 213, 223 of the first contacts 21 and the second contacts 22 have a same width and are aligned in one row along the left-to-right direction.

The first contacts 21 have two first grounding contacts 210 spaced away from each other in the left-to-right direction. The second contacts 22 have three second grounding contacts 220 spaced away from each another. The retaining portion 211 of each of the first grounding contact 210 is integrated with the retaining portion 221 of one second grounding contact 220 and allows two retaining portions 211, 221 to be retained in one passageway 101. The first grounding contacts 210 and corresponding integrated second grounding contact 210, 220 jointly have a same soldering tail 2103 for decreasing a distance between two adjacent soldering tails 213, 223 of the contacts 2. Therefore, it decrease mounting space of the printed circuit board for the soldering tails 213, 223. Of course, the retaining portion 211 of the first grounding contact 210 may not be integrated with the retaining portion 221 of the second grounding contact 220 but just electrically contact with retaining portion 221 of the second grounding contact 220 in other embodiment as to achieve the above effects.

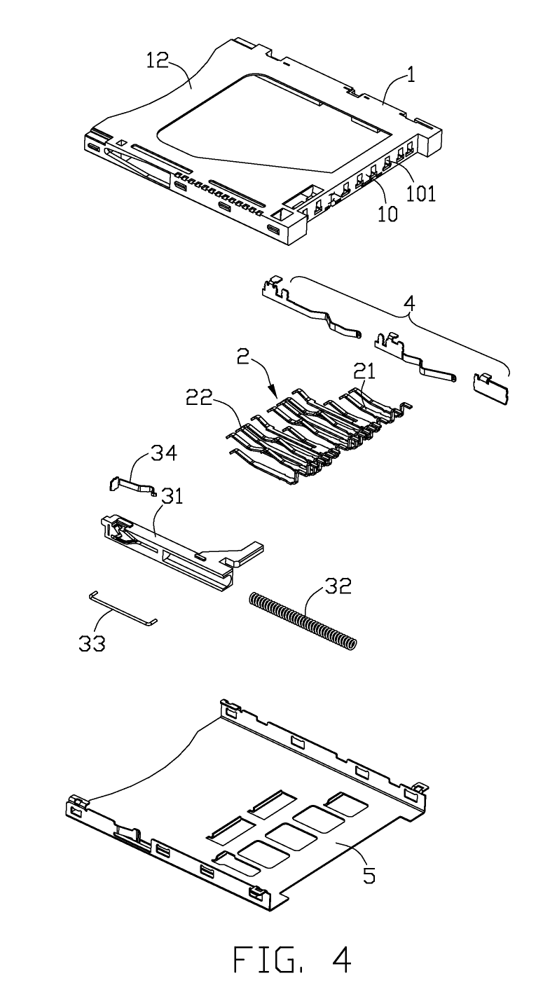

Referring to FIG. 4, the ejector mechanism 3 is received in a side wall 11 of the housing 1, and includes a slider 31, a coil spring 32 abuting against the slider 31, a lever 33 and a locking plate 34 secured on the slider 31 for locking with the first card and the second card 200. The switch 4 is retained in the other side wall 11 of the housing 1.

The metal shell 5 includes a top plate 51 covering a top of the inserting slot 15, and a pair of side plates 52 bent downwardly from the top plate 51 and fixed on the pair of side walls 11 of the housing 1, respectively. The top plate 51 defines a plurality of openings 512 aligned with the contact portions 212, 222 and allowing deflection of the contact portions 212, 222 for preventing the contacts 2 from touching with the metal shell 5.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical card connector, adapted for being mounted on a printed circuit board, comprising:
an insulative housing having an inserting slot for receiving a card; and
a plurality of contacts retained in the housing respectively and including a plurality of first contacts, and a plurality of second contacts cooperating with the first contacts for engaging with the card, each of the first contacts and the second contacts having a retaining portion fixed with the housing, a contact portion protruding into the inserting slot from the retaining portion, and a soldering portion extending beyond the housing from the retaining portion, the contact portions of the first contacts arranged in one row extending along a left-to-right direction, the contact portions of the second contacts are arranged in another row parallel to the row;
wherein at least one of the first contacts and one of the second contacts share a same soldering tail.

2. The electrical card connector as claimed in claim 1, wherein the at least one of the first contacts and one of the second contact are integrated with each other so as to share the same soldering tail.

3. The electrical card connector as claimed in claim 1, wherein the contacts that share a same soldering tail are grounding contacts.

4. The electrical card connector as claimed in claim 3, wherein the contacts that share a same soldering tail have a same retaining portion retained in one passageways of the housing.

5. The electrical card connector as claimed in claim 1, wherein the first contacts have two first grounding contacts spaced away from each other, and the second contacts have three second grounding contacts spaced away from each another, each of the first grounding contacts share a same soldering tail with one second grounding contact.

6. The electrical card connector as claimed in claim 1, wherein the contact portions of the first and the second contacts are positioned at a same level along an upper-to-lower direction, the soldering tails of the first and the second contacts have a same width and are aligned in one row.

7. The electrical card connector as claimed in claim 1, wherein the first contacts are adapted for engaging with a SD card.

8. The electrical card connector as claimed in claim 1, wherein the housing includes a base portion having a plurality of passageways receiving the retaining portions therein, a pair of side walls forwardly extending from the base portion to define the inserting slot thereamong, the contact portions of the first contacts are disposed closer to the base portion than the contact portions of the second contacts, the soldering tails of the first and the second contacts are aligned in one row along a left-to-right direction.

9. The electrical card connector as claimed in claim 1, further comprising a metal shell attached to the housing and having a top plate covering a top of the inserting slot, and a pair of side plates bent downwardly from the top plate, the top plate defines a plurality of openings aligned with the contact portions and allows deflection of the contact portions for preventing the contacts from touching with the shell.

10. An electrical card connector, comprising:
an insulative housing having an inserting slot; and
a plurality of contacts each having a retaining portion fixed with the housing, a contact portion protruding into the inserting slot, and a soldering tail extending beyond the housing from the retaining portion, the contact portions of the contacts are arranged in a first row and a second row disposed at front of the first row, both of rows of the contact portions being adapted for engaging with one card;
wherein the contact has a grounding contact, which has two contact portions located in the first and second rows respectively.

11. The electrical card connector as claimed in claim 12, wherein the soldering tails of the contacts are aligned in one row, only the first row of contacts are adapted for engaging with a SD card different from the one card.

12. The electrical card connector as claimed in claim 11, wherein the contacts includes three grounding contacts, and two of the grounding contacts have two contact portions while one of the grounding contacts only has a contact portion.

13. The electrical card connector as claimed in claim 11, further comprising a top metal plate covering the inserting slot and defining a plurality of openings aligned with the contact portions and allowing deflection of the contact portions for preventing the contacts from touching with the top plate.

14. An electrical card connector assembly comprising:
an insulative housing defining a card receiving space in communication with an exterior in a front-to-back direction;
a plurality of first contacts arranged with one another with corresponding first contacting sections in a first row along a transverse direction perpendicular to said front-to-back direction;
a plurality of second contacts arranged with one another with corresponding second contacting sections in a second row, along the transverse direction, spaced from and in front of the first row in the front-to-back direction; and
tails of both said first contacts and those of said second contacts being commonly arranged in a third row along the transverse direction; wherein at least one of the second contacts shares the same tail with the corresponding one first contact.

15. The electrical card connector as claimed in claim 14, wherein each of said first contacts defines a first retention section between the corresponding first contacting section and tail, and each of said second contacts defines a second retention section between the corresponding second contacting section and tail under condition that most of the second retention sections are higher than the first retention sections in a vertical direction perpendicular to both said front-to-back direction and said transverse direction.

16. The electrical card connector as claimed in claim 15, wherein the second retention section of said at least one of the second contacts joins the first retention section of the corresponding one first contact in the transverse direction so as to be larger than any other first retention sections and second retention sections in the transverse direction.

17. The electrical card connector as claimed in claim 16, wherein the second contacting section of said at least one of the second contacts is intimately spaced, in the transverse direction, from the first contacting section of the corresponding one first contact.

18. The electrical card connector as claimed in claim 17, wherein the second contacting section of said at least one of the second contacts extends forwardly longer than those of the other second contacts, and the first contacting section of the corresponding one first contact is extends longer forwardly longer than those of other first contacts to perform a grounding function.

19. The electrical card connector as claimed in claim 16, wherein the second retention section of said at least one of the second contacts, which is joined with the first retention section of the corresponding one first contacts, is located at the same level with the first retention section.
